(19) United States
(12) Patent Application Publication
(10) Pub. No.: US 2025/0327599 A1
(43) Pub. Date: Oct. 23, 2025

(54) CLOSED-LOOP REFRIGERANT GAS COOLING DEVICE

(71) Applicant: ACME (BEIJING) TECHNOLOGY CO., LTD., Beijing (CN)

(72) Inventors: Hao Li, Beijing (CN); Chenshuai Shi, Beijing (CN)

(21) Appl. No.: 18/868,185

(22) PCT Filed: Jan. 18, 2023
(86) PCT No.: PCT/CN2023/072938

§ 371 Date: Nov. 22, 2024

(30) Foreign Application Priority Data
May 27, 2022 (CN) 202210594459.3

(51) Int. Cl. F25B 9/00; F25B 41/22

(52) U.S. Cl. CPC F25B 9/002; F25B 41/22; F25B 2500/13; F25B 2700/1933

(57) ABSTRACT

The present invention relates to the technical field of low-temperature refrigeration apparatuses. Provided is a closed-loop refrigerant gas cooling device. The closed-loop refrigerant gas cooling device comprises a refrigerant gas circulation assembly, a refrigeration assembly and a thermostat, wherein the refrigeration assembly comprises a heat insulation shell and a refrigerator mounted in the heat insulation shell; in the heat insulation shell, the thermostat is in communication with a gas output end of the refrigerant gas circulation assembly by means of a flexible delivery rod; and a gas intake end of the refrigerant gas circulation assembly is in communication with the thermostat.

### CROSS-REFERENCE TO RELATED APPLICATIONS

This application claims the priority of Chinese patent application CN 202210594459.3 submitted on May 27, 2022, the entirety of which is incorporated herein by reference.

### FIELD OF THE INVENTION

The present disclosure relates to the technical field of low-temperature refrigeration apparatuses, and in particular, to a closed-loop refrigerant gas cooling device.

### BACKGROUND OF THE INVENTION

As a non-renewable rare-gas resource, the refrigerant gas resource (such as the helium gas) originally has a very low content in nature, and is difficult to obtain, store, and transport. The helium gas, as an indispensable safe refrigerant to obtain a low temperature, has wide applications in various fields such as scientific research, medical treatment, and industry. With the development of the refrigerator technology in recent years, the closed-loop refrigeration technology makes it possible to reuse the helium gas resource, and has a great market potential. However, reciprocating mechanical parts and airflow in the refrigerator may generate relatively large mechanical vibrations, so that the closed-loop refrigeration technology is limited in applications with high demands on vibration.

### SUMMARY OF THE INVENTION

With respect to problems in existing technologies, this application provides a closed-loop refrigerant gas cooling device to solve the technical problem that reciprocating mechanical parts and airflow in the refrigerator generate relatively large mechanical vibrations, which limits application of the closed-loop refrigeration technology with high demands on vibration.

The present disclosure provides a closed-loop refrigerant gas cooling device, and the closed-loop refrigerant gas cooling device includes:
a refrigerant gas circulation assembly;
a refrigeration assembly, which includes a heat insulation shell and a refrigerator mounted in the heat insulation shell, wherein a compressor of the refrigeration assembly is in communication with the refrigerator via a high-pressure helium gas pipe; and
a thermostat, which is in communication with a gas output end of the refrigerant gas circulation assembly via a flexible delivery rod in the heat insulation shell, and is in communication with a gas intake end of the refrigerant gas circulation assembly;
wherein the refrigerator cools a refrigerant gas in the refrigerant gas circulation assembly located in the heat insulation shell, and the refrigerant gas cooled enters the thermostat via the flexible delivery rod to cool the thermostat and enters the refrigerant gas circulation assembly for circulation.

Further improvements on the above technical solutions are as follows.

According to the above closed-loop refrigerant gas cooling device, further, the refrigerant gas circulation assembly includes a circulation pump, wherein a gas output end of the circulation pump is in communication with the flexible delivery rod via a gas output circulation pipe, and a gas intake end of the circulation pump is in communication with the thermostat via a gas intake circulation pipe.

According to the above closed-loop refrigerant gas cooling device, further, the refrigerant gas circulation assembly also includes a refrigerant gas storage tank which is in communication with the gas output circulation pipe via a pipe to supply the refrigerant gas to the refrigerant gas circulation assembly.

According to the above closed-loop refrigerant gas cooling device, further, the pipe is provided thereon with a seal valve.

According to the above closed-loop refrigerant gas cooling device, further, the gas intake circulation pipe or the gas output circulation pipe is provided thereon with a first gas evacuation port which is configured for performing vacuum evacuation on the gas intake circulation pipe and the gas output circulation pipe.

According to the above closed-loop refrigerant gas cooling device, further, the gas intake circulation pipe or the gas output circulation pipe is provided thereon with a needle valve and a safety valve, wherein the needle valve is configured to adjust a flow velocity of the refrigerant gas in the gas intake circulation pipe and the gas output circulation pipe, and the safety valve is configured to control a pressure in the gas intake circulation pipe or the gas output circulation pipe so as to prevent damages on the device caused by excessive pressure.

According to the above closed-loop refrigerant gas cooling device, further, the gas intake circulation pipe or the gas output circulation pipe is provided thereon with a pressure gauge which is configured to monitor the pressure in the gas intake circulation pipe and the gas output circulation pipe.

According to the above closed-loop refrigerant gas cooling device, further, the refrigeration assembly also includes a first support which is configured for placing the heat insulation shell and is placed on the ground via a vibration isolation rubber pad.

According to the above closed-loop refrigerant gas cooling device, further, the closed-loop refrigerant gas cooling device also includes a second support on which the flexible delivery rod is placed via a fixation press block and which is placed on the ground via a vibration isolation rubber pad.

According to the above closed-loop refrigerant gas cooling device, further, the heat insulation shell is provided thereon with a second gas evacuation port which is configured for performing vacuum evacuation of the interior of the heat insulation shell.

The above technical features may be combined in various suitable manners or be replaced by equivalent technical features, as long as the purpose of the present disclosure can be realized.

Compared with existing technologies, the closed-loop refrigerant gas cooling device has at least the following beneficial effects. When in use, the refrigerant gas circulation assembly is initiated, and the refrigerant gas is filled into the refrigerant gas circulation assembly which cools the refrigerant gas in the refrigerant gas circulation assembly located in the heat insulation shell by means of the refrigerator mounted in the heat insulation shell. The refrigerant gas cooled enters the thermostat via the flexible delivery rod under the action of the refrigerant gas circulation assembly to cool the thermostat, and the thermostat has flow resistance therein and can be further cooled. After that, the refrigerant gas enters the refrigerant gas circulation assembly under the action of the refrigerant gas circulation assembly for circulation. By using the closed-loop refrigerant gas cooling device provided by the present disclosure, since the thermostat and the refrigeration assembly which are configured for cooling an apparatus needing cooling are positioned at a great distance from each other and the thermostat and the refrigeration assembly are connected via the flexible delivery rod, the impact on the apparatus needing cooling of relatively large mechanical vibrations, which are generated by reciprocating mechanical parts and airflow in the refrigerator, can be effectively reduced, and thus the application range of the closed-loop refrigerant gas cooling device is greatly expanded.

The closed-loop refrigerant gas cooling device provided by the present disclosure has a better vibration attenuation effect. The refrigerator may cool the refrigerant gas in the refrigerant gas circulation assembly located in the heat insulation shell, and a minimum base temperature that can be achieved is lower than a temperature that can be achieved by existing cooling devices. The refrigeration assembly is mounted at a different position, and the refrigerant gas cooled enters the thermostat via the flexible delivery rod to cool the thermostat, which can eliminate low frequency vibrations inherent to the refrigeration assembly, thereby reducing vibrations of the closed-loop refrigerant gas cooling device. Moreover, the closed-loop refrigerant gas cooling device provided by the present disclosure further has a small volume and has low requirements for the operation environment, so that it can be applied in external conditions, such as a high temperature and a magnetic field, which have impact on the refrigerator. The thermostat of closed-loop refrigerant gas cooling device provided by the present disclosure may be arranged and mounted at any angle, which expands the application of the closed-loop refrigerant gas cooling device. The closed-loop refrigerant gas cooling device provided by the present disclosure has a broader and more precise variable temperature range, can expand to a lower temperature range, and can reach a lower temperature by flow resistance and pressure reduction, thereby providing a possibility of expanding to a lower temperature.

In order to make the above objective, features and advantages of the present disclosure more clear and understandable, detailed description is provided below in conjunction with preferred embodiments with reference to the accompanying drawings.

### BRIEF DESCRIPTION OF THE DRAWINGS

In order to describe technical solutions of embodiments of the present disclosure more clearly, accompanying drawings needed in the embodiments are introduced briefly. It should be understood that, the following drawings only illustrate some embodiments of the present disclosure, and thus should not be construed as limitations on the scope. Those of ordinary skills in the art may also obtain other relevant drawings based on these drawings without making creative efforts.

The present disclosure will be described in a more detailed manner below based on embodiments and with reference to accompanying drawings.

FIG. 1 schematically shows a structure of a closed-loop helium gas cooling device provided in an embodiment of the present disclosure;

FIG. 2 schematically shows a structure of an ultra-high vacuum scanning tunneling microscope provided in an embodiment of the present disclosure;

FIG. 3 schematically shows a structure of a multi-dimensional sample worktop provided in an embodiment of the present disclosure; and

FIG. 4 schematically shows a structure of a low-temperature strong magnetic field delivery system provided in an embodiment of the present disclosure.

In the accompanying drawings, same reference numerals are used for same components. The accompanying drawings are not drawn according to actual proportions.

### REFERENCE NUMERALS

100—closed—loop helium gas cooling device; 110—refrigerant gas circulation assembly; 111—circulation pump; 112—gas output circulation pipe; 113—gas intake circulation pipe; 114—helium gas storage tank; 120—first gas evacuation port; 121—needle valve; 122—safety valve; 123—pressure gauge; 130—refrigeration assembly; 131—heat insulation shell; 132—refrigerator; 133—first support; 134—vibration isolation rubber pad; 135—second support; 136—fixation press block; 137—vacuum sandwich layer; 138—second gas evacuation port; 139—compressor; 140—thermostat; 150—flexible delivery rod;
200—ultra-high vacuum scanning tunneling microscope; 210—scan probe; 220—damping vibration isolation device; 240—inner-layer thermal shield; 230—outer—layer thermal shield; 250—vacuum cavity; 260—vacuum pump; 270—vibration isolator; 280—system support;
300—multi-dimensional sample worktop;
400—delivery system; 410—sample; 420—thermal shield; 430—measurement signal line; 440—superconducting magnet; 450—vacuum cavity; 460—vacuum pump; 470—optical platform.

### DETAILED DESCRIPTION OF THE EMBODIMENTS

Embodiments of the present disclosure are described in detail below, and examples of the embodiments are shown in the accompanying drawings, throughout which identical or similar numerals indicate identical or similar elements or elements having identical or similar functions. The embodiments described below with reference to the drawings are illustrative, are intended to explain the present disclosure only, and cannot be construed as limitations on the present disclosure.

In the description of the present disclosure, it should be understood that directional or positional relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, and “circumferential” are directional or positional relationships based on illustrations in the drawings. These terms are used only for the convenience of describing the present disclosure and simplifying the description, and do not indicate or imply that the mentioned device or element must have a specific direction or be constructed and operated in a specific direction. Therefore, these terms should not be construed as limitations on the present disclosure.

Furthermore, terms “first” and “second” are used merely for the descriptive purpose and should not be understood as indicating or implying relative importance or implicitly indicating the number of the mentioned technical feature. Thus, a feature defined by “first” or “second” may indicate or imply that one feature or more features are included. In the description of the present disclosure, the term “multiple” means two or more unless otherwise specifically defined.

In the present disclosure, unless otherwise expressly specified and limited, terms such as “mount”, “couple”, “connect”, “fix” should be understood in a broad sense. For example, these terms may refer to a fixed connection, a detachable connection, or an integral formation; these terms may refer to a mechanical connection, or an electrical connection; and these terms may refer to a direct connection, an indirect connections through an intermediary, or internal connectivity between two elements or an interaction relationship between two elements. For those of ordinary skills in the art, specific meanings of these terms in the context of the present disclosure can be understood according to specific circumstances.

In the present disclosure, unless otherwise expressly specified and limited, a first feature being “upper” or “lower” than a second feature may indicate that the first feature and the second feature are in direct contact with each other or in indirect contact with each other via an intermediary. Moreover, the first feature being “on”, “above”, and “over” the second feature may indicate that the first feature being exactly or obliquely upper than the second feature or merely indicate that the first feature has a level greater than that of the second feature. The first feature being “beneath”, “below”, and “under” the second feature may indicate that the first feature being exactly or obliquely lower than the second feature or merely indicate that the first feature has a level less than that of the second feature.

The present disclosure will be further described with reference to the accompanying drawings.

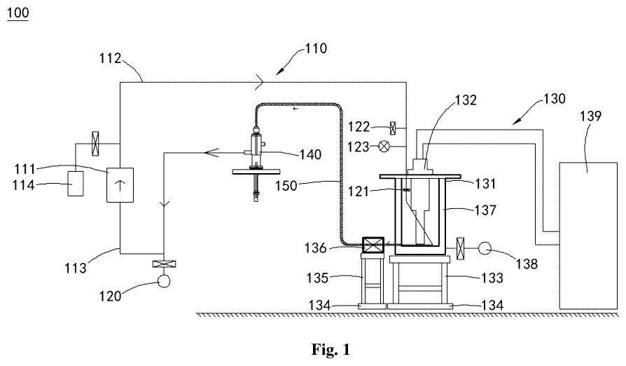

Please refer to FIG. 1, in the closed-loop refrigerant gas cooling device provided by an embodiment of the present disclosure, the helium gas is selected to be the refrigerant gas. That is, the closed-loop refrigerant gas cooling device provided by the embodiment of the present disclosure is a closed-loop helium gas cooling device 100. The closed-loop helium gas cooling device 100 includes a helium gas circulation assembly, a refrigeration assembly 130, and a thermostat 140. The refrigeration assembly 130 includes a heat insulation shell 131 and a refrigerator 132 mounted in the heat insulation shell 131, and a compressor 139 of the refrigeration assembly 130 is in communication with the refrigerator 132 via a high-pressure helium gas pipe; the thermostat 140 is in communication with a gas output end of the refrigerant gas circulation assembly 110 via a flexible delivery rod 150 in the heat insulation shell 131, and is in communication with a gas intake end of the refrigerant gas circulation assembly 110; and the refrigerator 132 cools a refrigerant gas in the refrigerant gas circulation assembly 110 located in the heat insulation shell 131, and the refrigerant gas cooled enters the thermostat 140 via the flexible delivery rod 150 to cool the thermostat 140 and enters the refrigerant gas circulation assembly 110 for circulation.

When in use, the refrigerant gas circulation assembly 110 is initiated, and the refrigerant gas is filled into the refrigerant gas circulation assembly 110 which cools the refrigerant gas in the refrigerant gas circulation assembly 110 located in the heat insulation shell 131 by means of the refrigerator 132 mounted in the heat insulation shell 131. The refrigerant gas cooled enters the thermostat 140 via the flexible delivery rod 150 under the action of the refrigerant gas circulation assembly 110 to cool the thermostat 140, and the thermostat has flow resistance therein and can be further cooled. After that, the refrigerant gas enters the refrigerant gas circulation assembly 110 under the action of the refrigerant gas circulation assembly 110 for circulation.

By using the closed-loop helium gas cooling device 100 provided by the embodiment of the present disclosure, since the thermostat 140 and the refrigeration assembly 130 which are configured for cooling an apparatus needing cooling are positioned at a great distance from each other and the thermostat 140 and the refrigeration assembly 130 are connected via the flexible delivery rod 150, the impact on the apparatus needing cooling of relatively large mechanical vibrations, which are generated by reciprocating mechanical parts and airflow in the refrigerator, can be effectively reduced, and thus the application range of the closed-loop helium gas cooling device 100 is greatly expanded.

The closed-loop helium gas cooling device 100 provided by the embodiment of the present disclosure has a better vibration attenuation effect. The refrigerator 132 may cool the refrigerant gas in the refrigerant gas circulation assembly 110 located in the heat insulation shell 131, and a minimum base temperature that can be achieved is lower than a temperature that can be achieved by existing cooling devices. The refrigeration assembly 130 is mounted at a different position, and the refrigerant gas cooled enters the thermostat 140 via the flexible delivery rod 150 to cool the thermostat 140, which can eliminate low frequency vibrations inherent to the refrigeration assembly 130, thereby reducing vibrations of the closed-loop refrigerant gas cooling device 100. Moreover, the closed-loop helium gas cooling device 100 provided by the embodiment of the present disclosure further has a small volume and has low requirements for the operation environment, so that it can be applied in external conditions, such as a high temperature and a magnetic field, which have impact on the refrigerator. The thermostat 140 of the closed-loop helium gas cooling device 100 provided by the embodiment of the present disclosure may be arranged and mounted at any angle, which expands the application of the closed-loop helium gas cooling device 100. The closed-loop helium gas cooling device 100 provided by the embodiment of the present disclosure has a broader and more precise variable temperature range, can expand to a lower temperature range, and can reach a lower temperature by flow resistance and pressure reduction, thereby providing a possibility of expanding to a lower temperature.

According to the closed-loop helium gas cooling device 100 provided by the embodiment of the present disclosure, specifically, a helium gas circulation assembly includes a circulation pump 111. A gas output end of the circulation pump 111 is in communication with the flexible delivery rod 150 via a gas output circulation pipe 112, and a gas intake end of the circulation pump 111 is in communication with the thermostat 140 of the gas intake circulation pipe 113. The circulation pump 111 provides power for flowing of the helium gas. When in use, the circulation pump 111 is initiated, and the refrigerant gas circulation assembly 110 cools the refrigerant gas in the refrigerant gas circulation assembly 110 located in the heat insulation shell 131 by means of the refrigerator 132 mounted in the heat insulation shell 131. The refrigerant gas cooled enters the thermostat 140 via the flexible delivery rod 150 under the action of the circulation pump 111 to cool the thermostat 140. After that, the refrigerant gas enters the refrigerant gas circulation assembly 110 under the action of the circulation pump 111 for circulation.

In a specific embodiment, a portion of the gas output circulation pipe 112 is sufficiently thermally connected with (for example, wound on) the refrigerator 132 mounted in the heat insulation shell 131 to cool the refrigerant gas. A mechanical circulation pump is selected to be the circulation pump 111, or other forms of apparatus may also be selected. A continuous flow thermostat 140 or a Dewar low-temperature thermostat 140 is selected to be the thermostat 140, and a lower temperature can be realized by schemes such as adding a throttling refrigeration device at the bottom of the thermostat 140, combining with the use of He₃ gas, and adding dilution refrigeration.

Alternatively, a resistor or other heating component is added at the bottom of the thermostat 140, so that the thermostat 140 is upgraded to be a precise variable temperature apparatus. Certainly, it can be understood that other types of pump may be selected to be the circulation pump 111 and other types of thermostat 140 may be selected to be the thermostat 140. Limitations are not made herein.

According to the closed-loop helium gas cooling device 100 provided by the embodiment of the present disclosure, further, the helium gas circulation assembly also includes a helium gas storage tank 114, and the helium gas storage tank 114 is in communication with the gas output circulation pipe 112 via a pipe. Moreover, the pipe is provided thereon with a seal valve to control opening and closing of the pipe.

According to the closed-loop helium gas cooling device 100 provided by the embodiment of the present disclosure, further, the gas intake circulation pipe 113 or the gas output circulation pipe 112 is provided thereon with a first gas evacuation port 120, and the first gas evacuation port 120 is configured for performing vacuum evacuation on the gas intake circulation pipe 113 and the gas output circulation pipe 112, so that the gas intake circulation pipe 113 and the gas output circulation pipe 112 are filled with pure helium gas, thereby improving the cooling efficiency of the helium gas.

According to the closed-loop helium gas cooling device 100 provided by the embodiment of the present disclosure, further, the gas intake circulation pipe 113 or the gas output circulation pipe 112 is provided thereon with a needle valve 121 and a safety valve 122. The needle valve 121 is configured to adjust a flow velocity of the helium gas in the gas intake circulation pipe 113 and the gas output circulation pipe 112, and the safety valve 122 is configured to control a pressure in the gas intake circulation pipe 113 or the gas output circulation pipe 112. By using the needle valve 121 to adjust the flow velocity of the helium gas in the gas intake circulation pipe 113 and the gas output circulation pipe 112, the cooling efficiency of the closed-loop helium gas cooling device 100 provided by the embodiment of the present disclosure can be controlled. The safety valve 122 is automatically opened when it is detected that the pressure in the gas intake circulation pipe 113 or the gas output circulation pipe 112 is excessive, so as to avoid the explosion risk for the gas intake circulation pipe 113 or the gas output circulation pipe 112.

According to the closed-loop helium gas cooling device 100 provided by the embodiment of the present disclosure, further, the gas intake circulation pipe 113 or the gas output circulation pipe 112 is provided thereon with a pressure gauge 123, and the pressure gauge 123 is configured to monitor the pressure in the gas intake circulation pipe 113 and the gas output circulation pipe 112, so as to avoid safety accidents caused by excessive pressure in the gas intake circulation pipe 113 and the gas output circulation pipe 112.

According to the closed-loop helium gas cooling device 100 provided by the embodiment of the present disclosure, further, the refrigeration assembly 130 also includes a first support 133 configured for placing the heat insulation shell 131, and the first support 133 is placed on the ground via a vibration isolation rubber pad 134. The closed-loop helium gas cooling device 100 also includes a second support 135, on which the flexible delivery rod 150 is placed via a fixation press block 136, and the second support 135 is placed on the ground via a vibration isolation rubber pad 134. The vibration isolation rubber pad 134 can reduce the impact on the apparatus needing cooling of vibrations generated by the heat insulation shell 131 and the flexible delivery rod 150 during operation. The fixation press block 136 fixes the flexible delivery rod 150 on the second support 135, so as to further reduce the impact on the apparatus needing cooling of vibrations generated during operation.

In a specific embodiment, the first support 133 and the second support 135 are made of steel, and the fixation press block 136 is made of a rubber material, which can further reduce the impact on the apparatus needing cooling of vibrations generated during operation of the closed-loop helium gas cooling device 100 provided by the embodiment of the present disclosure. Certainly, it can be understood that, the first support 133 and the second support 135 may also be made of other materials, the fixation press block 136 may also be made of other vibration attenuation materials, and the vibration isolation rubber pad 134 may also be replaced by a spring vibration isolation board, a sandbag, and the like. Limitations are not made herein.

According to the closed-loop helium gas cooling device 100 provided by the embodiment of the present disclosure, further, the heat insulation shell 131 is provided thereon with a second gas evacuation port 138, and the second gas evacuation port 138 is configured for performing vacuum evacuation of the interior of the heat insulation shell 131. Since vacuum has advantages of heat insulation, sound insulation, and vibration isolation, performing vacuum evacuation of the interior of the heat insulation shell 131 improves the efficiency of cooling the refrigerant gas in the refrigerant gas circulation assembly 110 located in the heat insulation shell 131 by the refrigerator 132 and avoids the impact on the apparatus needing cooling of vibrations generated by parts in the heat insulation shell 131 during operation of the closed-loop helium gas cooling device 100 provided by the embodiment of the present disclosure.

According to the closed-loop helium gas cooling device 100 provided by the embodiment of the present disclosure, further, the compressor 139 of the refrigeration assembly 130 is in communication with the refrigerator 132 via a high-pressure helium gas pipe, and a gas output end of the compressor 139 is also in communication with the refrigerator 132 via a gas delivery pipe. The compressor 139 may be a Gifford-Mcmahon cycle refrigerator, a pulse tube refrigerator, a Stirling cycle refrigerator, or an improved model based on principles of these refrigerators.

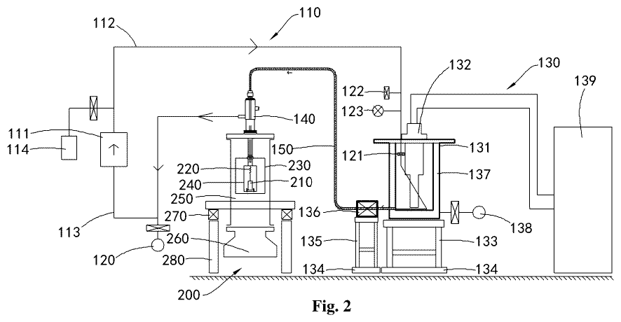

Please refer to FIG. 2, an embodiment of the present disclosure provides an ultra-high vacuum scanning tunneling microscope 200, and a scan probe 210 is suspended under the continuous flow low-temperature thermostat 140 via a spring, and is wrapped by two thermal shield layers, i.e., an inner-layer thermal shield 240 and an outer-layer thermal shield 230. The two thermal shield layers are made of a high thermal conductivity material, and the inner-layer thermal shield 240 and the outer-layer thermal shield 230 are respectively connected with the continuous flow low-temperature thermostat 140. The spring and a magnet fixed at the inner-layer thermal shield 240 form a damping vibration isolation device 220 of the scan probe 210. The scan probe 210 contains a temperature sensor therein to monitor the temperature thereof. The entire device is fixed on a system support 280, and the system support 280 is equipped with a vibration isolator 270 to isolate vibrations from the environment. A vacuum cavity 250 and a vacuum pump 260 (the vacuum pump 260 mainly refers to a pump usable to create an ultra-high vacuum environment, such as a mechanical pump, a molecular pump, and an ion pump) are configured for establishing an ultra-high vacuum environment.

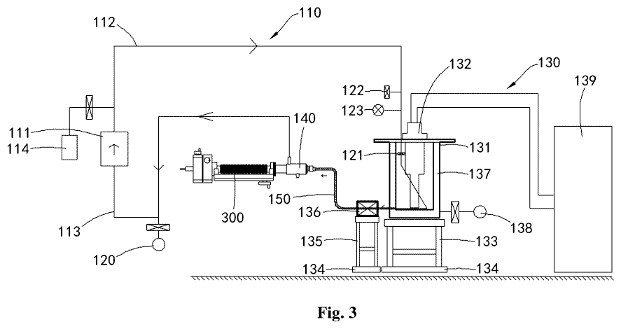

Please refer to FIG. 3, an embodiment of the present disclosure provides a multi-dimensional sample worktop 300.

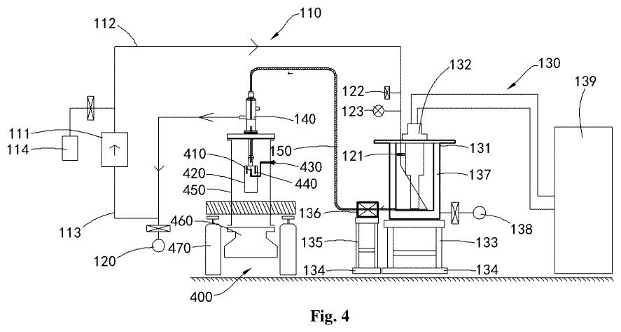

Please refer to FIG. 4, an embodiment of the present disclosure provides a low-temperature strong magnetic field delivery system 400. A sample 410 is placed in a thermal shield 420, and the thermal shield 420 is placed in a vacuum cavity 450. The sample 410 is connected with a measurement signal line 430, and two superconducting magnets 440 are suspended in the thermal shield 420 at both sides of the sample 410. A vacuum pump 460 is provided below the vacuum cavity 450, and the vacuum cavity 450 is mounted on an optical platform 470.

In the description of this specification, the description using reference terms such as “one embodiment”, “some embodiments”, “example”, “specific example”, or “some examples” indicates that specific features, structures, materials, or characteristics described in conjunction with the embodiment or example are included in at least one embodiment or example of the present disclosure. In this specification, the illustrative use of these terms does not necessarily refer to the same embodiment or example. Moreover, the specific features, structures, materials, or characteristics described may be combined in a suitable manner in any one or more embodiments or examples. Additionally, those skilled in the art can integrate and combine different embodiments or examples described in this specification and features of the different embodiments or examples without contradictions.

Although the present disclosure is described in conjunction with specific implementation manners herein, it should be understood that these embodiments are merely examples of principles and applications of the present disclosure. Therefore, it should be understood that many modifications can be made to exemplary embodiments and other arrangements can be designed as long as the spirit and scope of the present disclosure defined by the appended claims are not departed from. It should be understood that different dependent claims and features described herein can be combined in ways different from those described in original claims. In addition, it should also be understood that features described in conjunction with an individual embodiment can be used in other described embodiments.

1. A closed-loop refrigerant gas cooling device, wherein the closed-loop refrigerant gas cooling device comprises:
a refrigerant gas circulation assembly;
a refrigeration assembly, which comprises a heat insulation shell and a refrigerator mounted in the heat insulation shell; and
a thermostat, which is in communication with a gas output end of the refrigerant gas circulation assembly via a flexible delivery rod in the heat insulation shell, and is in communication with a gas intake end of the refrigerant gas circulation assembly;
wherein the refrigerator cools a refrigerant gas in the refrigerant gas circulation assembly located in the heat insulation shell, and the refrigerant gas cooled enters the thermostat via the flexible delivery rod to cool the thermostat and enters the refrigerant gas circulation assembly for circulation.

2. The closed-loop refrigerant gas cooling device according to claim 1, wherein the refrigerant gas circulation assembly comprises a circulation pump, wherein a gas output end of the circulation pump is in communication with the flexible delivery rod via a gas output circulation pipe, and a gas intake end of the circulation pump is in communication with the thermostat via a gas intake circulation pipe.

3. The closed-loop refrigerant gas cooling device according to claim 2, wherein the refrigerant gas circulation assembly further comprises a refrigerant gas storage tank which is in communication with the gas output circulation pipe via a pipe to supply the refrigerant gas to the refrigerant gas circulation assembly.

4. The closed-loop refrigerant gas cooling device according to claim 3, wherein the pipe is provided thereon with a seal valve.

5. The closed-loop refrigerant gas cooling device according to claim 2, wherein the gas intake circulation pipe or the gas output circulation pipe is provided thereon with a first gas evacuation port which is configured for performing vacuum evacuation on the gas intake circulation pipe and the gas output circulation pipe.

6. The closed-loop refrigerant gas cooling device according to claim 2, wherein the gas intake circulation pipe or the gas output circulation pipe is provided thereon with a needle valve and a safety valve, wherein the needle valve is configured to adjust a flow velocity of the refrigerant gas in the gas intake circulation pipe and the gas output circulation pipe, and the safety valve is configured to control a pressure in the gas intake circulation pipe or the gas output circulation pipe.

7. The closed-loop refrigerant gas cooling device according to claim 2, wherein the gas intake circulation pipe or the gas output circulation pipe is provided thereon with a pressure gauge which is configured to monitor the pressure in the gas intake circulation pipe and the gas output circulation pipe.

8. The closed-loop refrigerant gas cooling device according to claim 1, wherein the refrigeration assembly further comprises a first support which is configured for placing the heat insulation shell and is placed on the ground via a vibration isolation rubber pad.

9. The closed-loop refrigerant gas cooling device according to claim 1, wherein the closed-loop refrigerant gas cooling device further comprises a second support on which the flexible delivery rod is placed via a fixation press block and which is placed on the ground via a vibration isolation rubber pad.

10. The closed-loop refrigerant gas cooling device according to claim 1, wherein the heat insulation shell is provided thereon with a second gas evacuation port which is configured for performing vacuum evacuation of the interior of the heat insulation shell.
